(19) United States
(12) Patent Application Publication
(10) Pub. No.: US 2025/0298281 A1
(43) Pub. Date: Sep. 25, 2025

(54) STIMULI-RESPONSIVE META-HOLOGRAPHIC DEVICE AND HOLOGRAM GENERATING DEVICE INCLUDING SAME

(71) Applicant: POSTECH RESEARCH AND BUSINESS DEVELOPMENT FOUNDATION, Pohang-si (KR)

(72) Inventors: Jun Suk RHO, Pohang-si (KR); Joo Hoon KIM, Pohang-si (KR); Jun Hyung IM, Pohang-si (KR); Young Ki KIM, Pohang-si (KR)

(73) Assignee: POSTECH RESEARCH AND BUSINESS DEVELOPMENT FOUNDATION, Pohang-si (KR)

(21) Appl. No.: 19/076,282

(22) Filed: Mar. 11, 2025

(30) Foreign Application Priority Data
Mar. 21, 2024 (KR) 10-2024-0039293
Jun. 24, 2024 (KR) 10-2024-0082283

(51) Int. Cl. G02F 1/139; G03H 1/22

(52) U.S. Cl. CPC G02F 1/1396; G03H 1/2205; G02F 2203/02; G02F 2203/055; G03H 2223/24

(57) ABSTRACT

According to an embodiment, it is possible to provide a stimuli-responsive meta-holographic device including a metasurface layer provided with a plurality of nanostructures, and a liquid crystal layer provided on one side of the metasurface layer and including a plurality of unit liquid crystal molecules of which arrangement may be changed by external stimulus, wherein, when light is incident on the liquid crystal layer, the liquid crystal layer reflects light of a specific wavelength region to the metasurface layer according to a degree of the external stimulus applied thereon.

### CROSS-REFERENCE TO RELATED APPLICATIONS

This application claims the benefit of and priority to Korean Patent Application No. 10-2024-0039293, filed on Mar. 21, 2024 and Korean Patent Application No. 10-2024-0082283 filed on Jun. 24, 2024. The entire contents of each of the foregoing applications are incorporated herein by reference for all purposes.

### TECHNICAL FIELD

The present disclosure relates to a stimuli-responsive meta-holographic device and a hologram generating device including the same.

### BACKGROUND

A metasurface is a planar optical element composed of nanostructures (or meta-atoms) having a size of an operating wavelength or less, and each nanostructure constituting the same exhibits optical characteristics (reflection, transmission and absorption spectrum, and phase) required for each position.

The reflection spectrum and phase are determined by resonance and propagation of an electric field and a magnetic field inside the nanostructure, and may be determined by a length, width, height, and refractive index of the nanostructure.

In order to implement the optical characteristics required in the visible light region, metasurfaces of several hundred nanometers in size are required, and production and application of such metasurfaces have become easy with development of nano-processes. Accordingly, the metasurfaces are being applied in various fields such as structural color printing, color filters, absorbers, and holographic displays.

In particular, a device capable of realizing structural color printing under white light by implementing reflection spectrum for each position and implementing hologram images under monochromatic laser light source by implementing phase information for each position at the same time has been proposed.

However, a conventional device for implementing the hologram images had a disadvantage that it was not able to control information stored after it was manufactured, and thus there was a disadvantage that an amount of the information that could be stored was limited.

### PRIOR ART

### [Patent Document]

Patent Document: Korean Registered Patent 10-2609550 B1 (Nov. 29, 2023)

### SUMMARY

### Technical Problem

Embodiments of the present disclosure are devised to solve the above problems, and are directed to providing of a stimuli-responsive meta-holographic device capable of increasing an amount of information that may be stored in a single metasurface layer, and a hologram generating device including the same.

In addition, the embodiments are directed to providing of the stimuli-responsive meta-holographic device capable of implementing a plurality of holograms in real time according to an external stimulus, and the hologram generating device including the same.

In addition, the embodiments are directed to providing of the stimuli-responsive meta-holographic device capable of generating a hologram without crosstalk by generating a reflection wavelength having a narrow bandwidth and high color purity, and the hologram generating device including the same.

In addition, the embodiments are directed to providing of the stimuli-responsive meta-holographic device that may be applied to optical-based forgery prevention a having high security level, and the hologram generating device including the same.

### Technical Solution

According to an embodiment, it is possible to provide a stimuli-responsive meta-holographic device including: a metasurface layer provided with a plurality of nanostructures; and a liquid crystal layer provided on one side of the metasurface layer and including a plurality of unit liquid crystal molecules of which arrangement may be changed by an external stimulus; wherein, when light is incident on the liquid crystal layer, the liquid crystal layer reflects light of a specific wavelength region to the metasurface layer according to a degree of the external stimulus applied thereon, and the plurality of unit liquid crystal molecules are arranged to have a specific cone angle with respect to a twisting axis to form a twisted-type liquid crystal composite.

In addition, the twisted-type liquid crystal composite may be provided to have an interlayer spacing formed at a constant period in a longitudinal direction of the twisting axis, and the interlayer spacing is changed according to the external stimulus.

In addition, the liquid crystal layer may have a pseudo-layer that is regularly arranged in a two-dimensional or a three-dimensional form, and the pseudo-layer may be formed by the interlayer spacing P of the twisted-type liquid crystal composite that is periodically arranged.

In addition, the twisted-type liquid crystal composite may have a spiral shape twisted around the twisting axis.

In addition, the external stimulus may be any one stimulus selected from a group consisting of an electric field, a temperature, a magnetic field, and an electric field frequency.

In addition, the light incident on the liquid crystal layer may be white light, only the light of a specific wavelength region in the white light may be reflected to the metasurface layer by the liquid crystal layer, and a bandwidth of the light of the specific wavelength region reflected to the metasurface layer may be provided to be less than 30 nm.

In addition, the light incident on the liquid crystal layer may be light with a wavelength range of 400 nm to 750 nm, and the light reflected toward the metasurface layer from the liquid crystal layer may be light in 10 different wavelength ranges according to the external stimulus.

In addition, the unit liquid crystal molecule may be provided to have right-handed chirality, and the metasurface layer may operate under right circularly polarized light to generate a hologram.

In addition, the liquid crystal layer may include the twisted-type liquid crystal composite having an interlayer spacing formed at a constant period, the external stimulus may be provided as an electric field, and the interlayer spacing may decrease as an intensity of the electric field increases.

In addition, the number of the interlayer spacings formed in the liquid crystal layer at the constant period may be provided in 8 to 60.

In addition, the nanostructure of the metasurface layer may be formed in a rectangular parallelepiped shape having a length, a width, and a height, and the length of the nanostructure may be provided at 350 nm to 430 nm, the width of the nanostructure may be provided at 100 nm to 120 nm, and the height of the nanostructure may be provided at 900 nm to 980 nm.

In addition, the liquid crystal layer may be provided to reflect light in the specific wavelength region by different types of the external stimuli, and the different types of external stimuli may include an electric field and a temperature.

In addition, the metasurface layer may be provided to be transmitted by light with a wavelength range of 420 nm and 720 nm to generate three or more different holograms.

In addition, the metasurface layer may be configured to be transmitted by light with a wavelength range of 420 nm and 720 nm to generate 10 different holograms.

In addition, the metasurface layer may be configured to be transmitted by light with a wavelength of 420 nm, 450 nm, 480 nm, 510 nm, 540 nm, 570 nm, 600 nm, 640 nm, 680 nm, and 720 nm to generate 10 different holograms.

According to an embodiment, it is possible to provide a hologram generating device including: the stimuli-responsive meta-holographic device of claim 1; a stimulus control device capable of applying an external stimulus to a liquid crystal layer of the stimuli-responsive meta-holographic device; and a light source capable of irradiating light to the stimuli-responsive meta-holographic device, wherein the stimulus control device is configured to apply different types of the external stimuli to the liquid crystal layer.

In addition, the light transmitted through the stimuli-responsive meta-holographic device may generate as holograms having different shapes and colors according to the external stimuli.

In addition, the liquid crystal layer may control the wavelength of the light reflected toward the metasurface layer differently according to the external stimulus, and the metasurface layer may generate holograms having different shapes and colors according to the wavelength of the light incident from the liquid crystal layer.

### Advantageous Effects

A stimuli-responsive meta-holographic device and a hologram generating device including the same according to an embodiment of the present disclosure have an advantage of increasing an amount of information that can be stored in a single metasurface layer.

In addition, there is an advantage of being capable of implementing a plurality of holograms in real time according to an external stimulus.

In addition, there is an advantage of being capable of generating a hologram without crosstalk by generating a reflection wavelength having a narrow bandwidth and high color purity.

In addition, there is an advantage of being applicable to optical-based forgery prevention having a high security level.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a conceptual view of a stimuli-responsive meta-holographic device according to an embodiment of the present disclosure.

FIG. 2 is a conceptual view of the stimuli-responsive meta-holographic device of FIG. 1 and various holograms generated thereby.

FIG. 3 is a conceptual view of a liquid crystal layer of the stimuli-responsive meta-holographic device of FIG. 1.

FIG. 4 is a conceptual view of a twisted-type liquid crystal composite formed by a plurality of unit liquid crystal molecules of the liquid crystal layer of FIG. 3.

FIG. 5 is a view showing a wavelength and a wavelength bandwidth of light reflected to a metasurface layer when an electric field E is applied as an external stimulus to the liquid crystal layer of FIG. 1.

FIG. 6 is a view showing a wavelength and a wavelength bandwidth of light reflected to the metasurface layer when temperature T is applied as the external stimulus to the liquid crystal layer of FIG. 1.

FIG. 7 is a conceptual view of a change in an interlayer spacing P as an electric field E (external stimulus) is applied to the liquid crystal layer of FIG. 1.

FIG. 8 is a view showing reflection spectrum of a unit liquid crystal molecule with respect to a wavelength reflected toward the metasurface layer according to an intensity of an electric field.

FIG. 9 is a view showing a reflection peak wavelength (indicated by a triangle shape) and a bandwidth (indicated by a circle shape) with respect to an electric field.

FIG. 10 is a view showing a hologram image according to an external stimulus after irradiating light on a stimuli-responsive meta-holographic device.

FIG. 11 is a conceptual view of an inverse design technique for designing a metasurface layer.

### DETAILED DESCRIPTION OF THE EMBODIMENTS

Hereinafter, specific embodiments of the present disclosure will be described in detail with reference to the drawings. In addition, when it is determined that a detailed description of the relevant known configuration or function may obscure the gist of the present disclosure, the detailed description will be omitted.

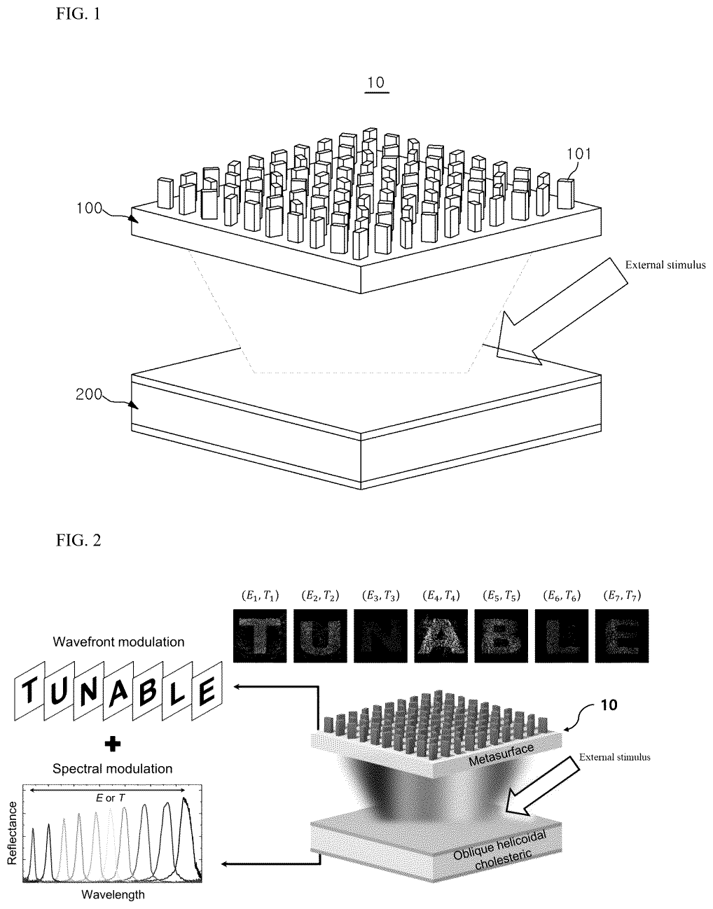

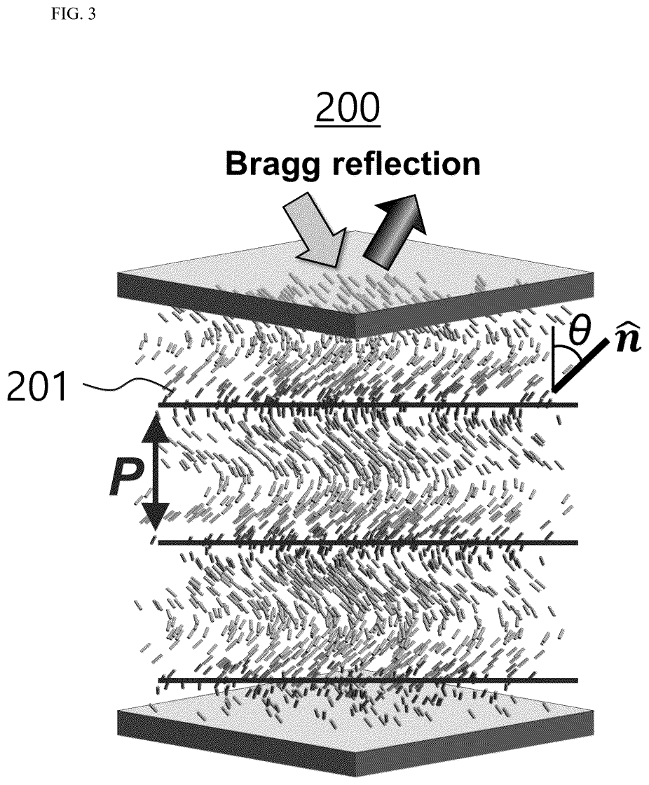

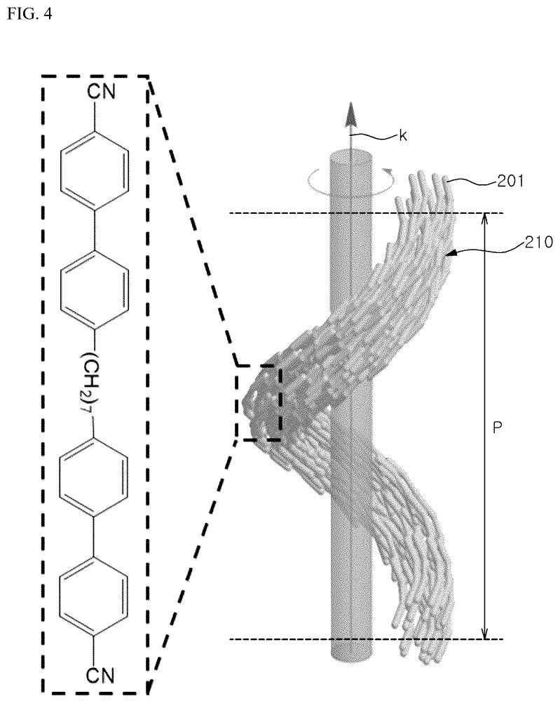

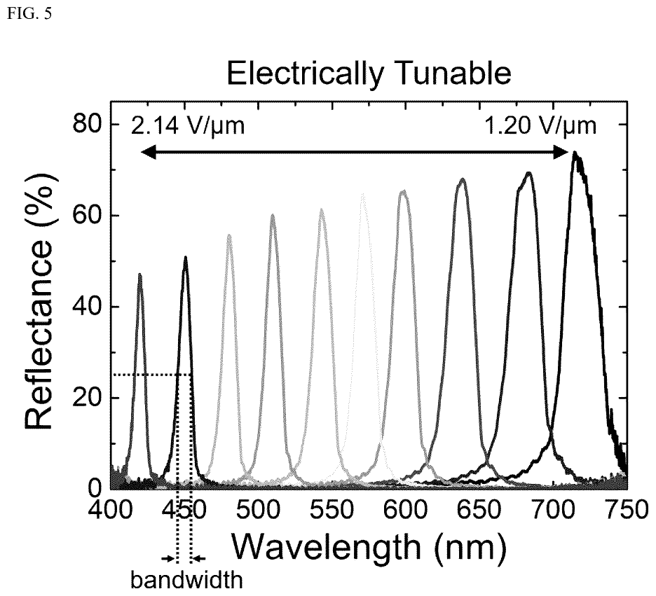

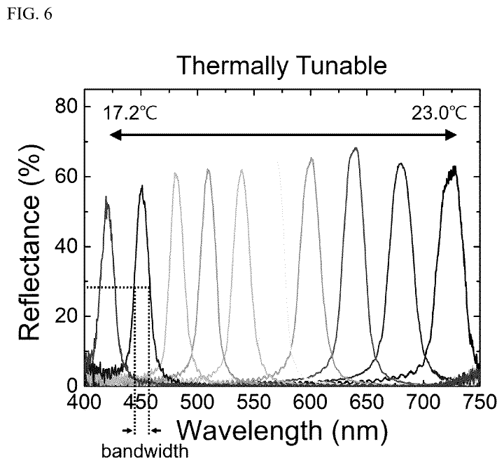

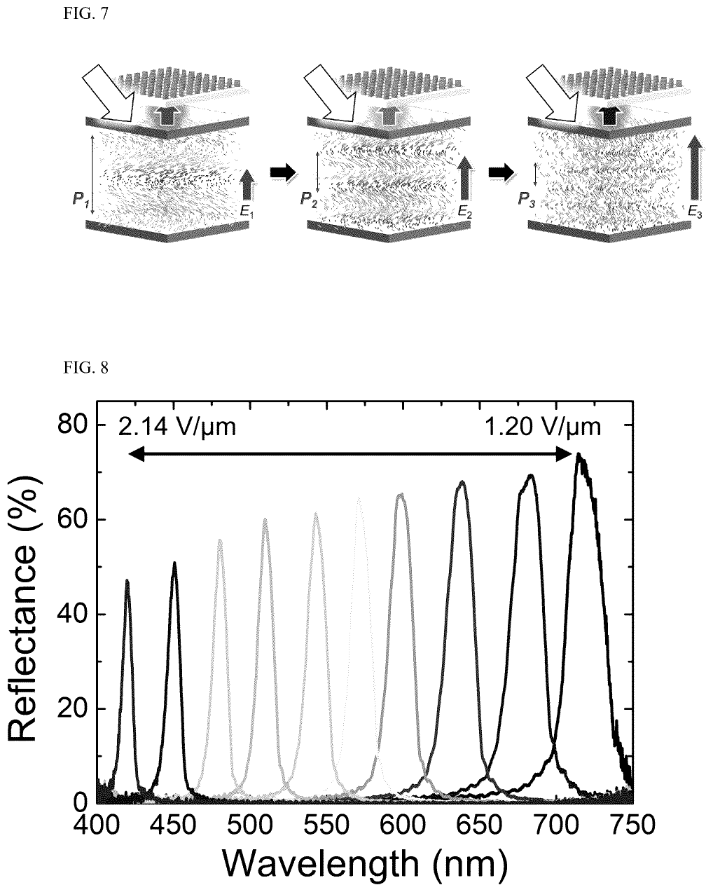

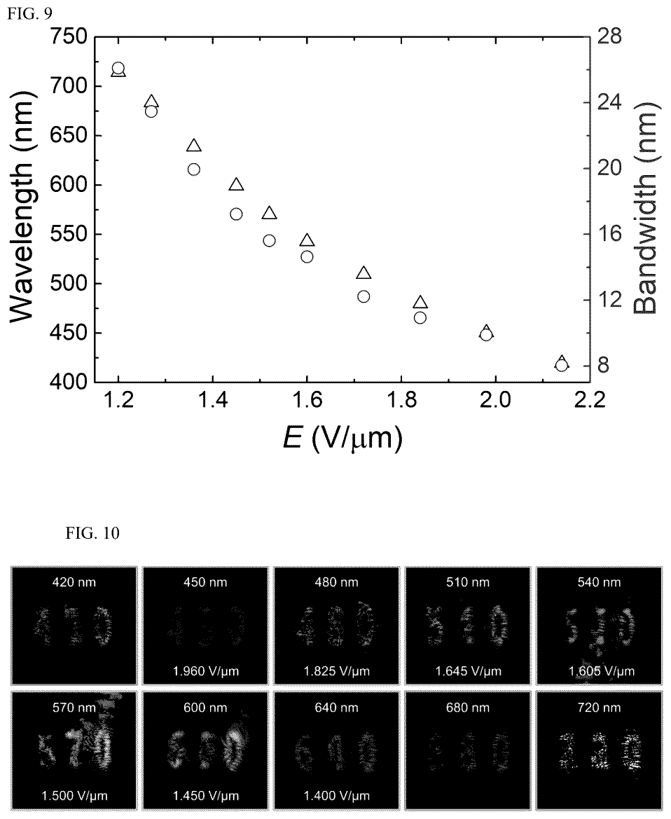

FIG. 1 is a conceptual view of a stimuli-responsive meta-holographic device 10 according to an embodiment of the present disclosure, FIG. 2 is a conceptual view of the stimuli-responsive meta-holographic device 10 of FIG. 1 and various holograms generated thereby, FIG. 3 is a conceptual view of a liquid crystal layer 200 of the stimuli-responsive meta-holographic device 10 of FIG. 1, FIG. 4 is a conceptual view of a twisted-type liquid crystal composite 210 formed by a plurality of unit liquid crystal molecules 201 of the liquid crystal layer 200 of FIG. 3, FIG. 5 is a view showing a wavelength and a wavelength bandwidth of light reflected to a metasurface layer 100 when an electric field E is applied as an external stimulus to the liquid crystal layer 200 of FIG. 1, FIG. 6 is a view showing a wavelength and a wavelength bandwidth of light reflected to the metasurface layer 100 when temperature T is applied as the external stimulus to the liquid crystal layer 200 of FIG. 1, FIG. 7 is a conceptual view of a change in an interlayer spacing P as an electric field E (external stimulus) is applied to the liquid crystal layer 200 of FIG. 1, FIG. 8 is a view showing reflection spectrum of a unit liquid crystal molecule 201 with respect to a wavelength reflected toward the metasurface layer 100 according to an intensity of an electric field, FIG. 9 is a view showing a reflection peak wavelength (black) and a bandwidth with respect to an electric field, and FIG. 10 is a view showing a hologram image according to an external stimulus after irradiating light on a stimuli-responsive meta-holographic device.

Referring to FIGS. 1 to 10, the stimuli-responsive meta-holographic device may include the metasurface layer 100 provided with a plurality of nanostructures 101, and a liquid crystal layer 200 provided on one side of the metasurface layer 100 and including a plurality of unit liquid crystal molecules 201 of which arrangement may be changed by an external stimulus.

When light is incident on the liquid crystal layer 200, the liquid crystal layer 200 may reflect light of a specific wavelength region to the metasurface layer 100 according to a degree of the external stimulus applied thereon.

In this case, the metasurface layer 100 may generate various holograms according to a wavelength region of the light.

The external stimulus may be provided by any one or two or more of an electric field, a temperature, a magnetic field, and an electric field frequency.

In the embodiment, the external stimuli will be described as an electric field and temperature.

The metasurface layer 100 of the embodiment is designed to greatly increase an amount of information by an inverse design technique so that 10 holograms may be stored in one device, and a pseudo-layered twisted-type liquid crystal thin film, which is the liquid crystal layer 200, may form a reflection wavelength having high color purity and change the reflection wavelength in response to both voltage and temperature, thereby obtaining a plurality of specific images of specific wavelengths without crosstalk through a combination of the two.

The metasurface layer 100 may be designed by the inverse design technique.

The inverse design technique may be understood as a design technique that corrects a phase-map for a difference between a value that predicts a result of a particular phase profile and a target value from a specific phase profile and continues such a cycle to create a phase-map close to a desired target.

For example, it is possible to design a shape, size, and arrangement of the nanostructure 101 of the metasurface layer 100 that may represent different holograms at each of 10 wavelengths (420 nm, 450 nm, 480 nm, 510 nm, 540 nm, 570 nm, 600 nm, 640 nm, 680 nm, 720 nm) using the inverse design technique.

Accordingly, when light (e.g., white light) is transmitted through the stimuli-responsive meta-holographic device 10, only the light of the specific wavelength region is reflected to the metasurface layer 100 by the liquid crystal layer 200, and the metasurface layer 100 may implement various holograms with different colors and shapes according to the wavelength region.

In addition, such technique may also be used in an optical security device. Specifically, two users may share temperature information and electric field information about a hologram that illuminates a password. In this case, the password may be known only when both of the two users provide correct information (temperature, electric field), and the password may not be known with only the temperature information or the electric field information, thereby having an advantage of enhancing security.

For example, referring to FIG. 2, when an electric field E1 (e.g., 0.95 V/μm) and temperature T1 (e.g., 17° C.) are input to the liquid crystal layer 200, the liquid crystal layer 200 may reflect only a specific wavelength region (e.g., 510 nm) to the metasurface layer 100, thereby generating a hologram having a green T-shape.

In addition, when an electric field E2 (e.g., 0.93 V/μm) and temperature T2 (e.g., 18° C.) are input to the liquid crystal layer 200, the liquid crystal layer 200 may reflect only another specific wavelength region (e.g., 600 nm) to the metasurface layer 100, thereby generating a hologram having a red U-shape.

In addition, when an electric field E3 (e.g., 1.30 V/μm) and temperature T3 (e.g., 19° C.) are input to the liquid crystal layer 200, the liquid crystal layer 200 may reflect only another specific wavelength region (e.g., 450 nm) to the metasurface layer 100, thereby generating a hologram having a blue N-shape.

In addition, when an electric field E4 (e.g., 1.21 V/μm) and temperature T4 (e.g., 20° C.) are input to the liquid crystal layer 200, the liquid crystal layer 200 may reflect only another specific wavelength region (e.g., 570 nm) to the metasurface layer 100, thereby generating a hologram having a yellow A-shape.

In addition, when an electric field E5 (e.g., 1.41 V/μm) and temperature T5 (e.g., 21° C.) are input to the liquid crystal layer 200, the liquid crystal layer 200 may reflect only another specific wavelength region (e.g., 540 nm) to the metasurface layer 100, thereby generating a hologram with a green B-shape.

In addition, when an electric field E6 (e.g., 1.23 V/μm) and temperature T6 (e.g., 22° C.) are input to the liquid crystal layer 200, the liquid crystal layer 200 may reflect only another specific wavelength region (e.g., 640 nm) to the metasurface layer 100, thereby generating a hologram having a red L-shape.

In addition, when an electric field E7 (e.g., 1.94 V/μm) and temperature T7 (e.g., 24° C.) are input to the liquid crystal layer 200, the liquid crystal layer 200 may reflect only another specific wavelength region (e.g., 480 nm) to the metasurface layer 100, thereby generating a hologram with a light blue E-shape. The metasurface layer 100 and the liquid crystal layer 200 may be stacked in parallel.

After light (e.g. white light) is incident on the liquid crystal layer 200, and after light of a specific wavelength region is incident on the metasurface layer 100, the light may transmit the metasurface layer 100 to create a hologram.

In order to generate various holograms without crosstalk by the stimuli-responsive meta-holographic device 10 and switch them, light of a precise wavelength with a narrow bandwidth should be incident on the metasurface layer 100.

In the embodiment, the liquid crystal layer 200 was selected for such purpose, and the liquid crystal layer 200 may precisely control a reflection wavelength of the narrow bandwidth by the external stimulus to transmit only the light of the specific wavelength region to the metasurface layer 100.

The liquid crystal layer 200 of the embodiment may be understood as the pseudo-layered twisted-type liquid crystal thin film.

The pseudo-layered twisted-type liquid crystal thin film is a plurality of unit liquid crystal molecules 201 disposed between two glass substrates, and the unit liquid crystal molecule 201 may be an oblique helicoidal cholesteric liquid crystal (ChOH).

The liquid crystal layer 200 may include the plurality of unit liquid crystal molecules 201 of which arrangement may be changed by the external stimulus.

The liquid crystal layer 200 may be arranged such that the plurality of unit liquid crystal molecules 201 has a specific cone angle with respect to a twisting axis k to form the twisted-type liquid crystal composite 210.

Here, the twisted-type liquid crystal composite 210 may be provided to have an interlayer spacing P formed at a constant period in a longitudinal direction of the twisting axis k, and the interlayer spacing P may be changed according to the external stimulus.

A plurality of the twisted-type liquid crystal composites 210 having such interlayer spacing P may be gathered to form a pseudo-layer.

Here, the twisting axis k may be understood as a virtual central axis representing a center around which the twisted-type liquid crystal composite 210 is twisted, and the longitudinal direction of the twisting axis k may be understood as a direction perpendicular to a direction in which the metasurface layer 100 is extended.

The liquid crystal layer 200 may have a pseudo-layer that is regularly arranged in a two-dimensional or a three-dimensional form. The pseudo-layer may be formed by the interlayer spacing P of the twisted-type liquid crystal composite 210 that is periodically arranged.

In the embodiment, the pseudo-layer may be understood as a virtual layered structure with a spiral pattern generated by repeatedly occurring a twist structure with a specific pitch without periodically changing “number density” of the unit liquid crystal molecule 201. Here, the “number density” may be defined as a number of the unit liquid crystal molecules 201 present in a unit volume. As the external stimulus is applied to the liquid crystal layer 200, the interlayer spacing P of the twisted-type liquid crystal composite 210 may be changed, and accordingly, the pseudo-layer may be changed.

Specifically, as the external stimulus is applied to the liquid crystal layer 200, the cone angle of each twisted-type liquid crystal composite 210 is changed, and accordingly, the interlayer spacing P may be changed.

More specifically, the plurality of unit liquid crystal molecules 201 may be arranged to form a cone angle deviated from the twisting axis k by a constant value to form the twisted-type liquid crystal composite 210, and the twisted-type liquid crystal composite 210 composed of the plurality of unit liquid crystal molecules 201 may also be arranged to form the cone angle.

When the external stimulus is applied to the liquid crystal layer 200, the cone angle of the twisted-type liquid crystal composite 210 is changed around the twisting axis k, so that the interlayer spacing P of the liquid crystal layer 200 may be changed.

Accordingly, the wavelength range of light reflected from the liquid crystal layer 200 may be controlled.

The twisted-type liquid crystal composite 210 formed of the plurality of unit liquid crystal molecules 201 may have a spiral shape twisted around the twisting axis k and may have a constant interlayer spacing P. In this case, a length of a continuous identical structure layer of the twisted-type liquid crystal composite 210 may be understood as the interlayer spacing P, and incident light may be selectively reflected by the continuous structure.

In addition, the number of the interlayer spacings P formed in the liquid crystal layer 200 at the constant period may be provided in 8 to 60, preferably 10 to 50, and more preferably 20 to 40. That is, a twisted-type liquid crystal composite 210 in which a same period is repeated in the number described above may be formed.

The liquid crystal layer 200 may be implemented by forming of a twist-bend nematic liquid crystal capable of simultaneously having a twist orientation and a bend orientation in a thin film, and then applying an electric field above a threshold voltage.

When the electric field is applied, the unit liquid crystal molecule 201 is arranged to have the cone angle, and the pseudo-layer is formed within the thin film. As a result, Bragg reflection is possible for incident light, thereby selectively reflecting only the light of the specific wavelength range toward the metasurface layer 100.

A wavelength of light reflected from the liquid crystal layer 200 is determined by an average refractive index of the unit liquid crystal molecules 201 and the interlayer spacing P.

The interlayer spacing P of the liquid crystal layer 200 may be sensitively controlled according to the external stimulus, thereby enabling precise control of the wavelength reflected from the liquid crystal layer 200 toward the metasurface layer 100.

In addition, the unit liquid crystal molecule 201 is twisted while forming a cone angle with respect to the twisting axis k, thereby forming a reflection wavelength having a very narrow bandwidth and high color purity.

Therefore, the specific wavelength of the light of the high color purity may be freely adjusted by one liquid crystal layer 200 to accurately transmit to the metasurface layer 100.

In addition, light incident on the liquid crystal layer 200 may be white light, only the light of the specific wavelength region in the white light may be reflected to the metasurface layer 100 by the liquid crystal layer 200, and a bandwidth of the light of the specific wavelength region reflected to the metasurface layer 100 may be provided to be less than 30 nm.

In addition, a temperature of 15° C. to 27° C. (preferably 16° C. to 25° C.) may be applied to the liquid crystal layer 200 as the external stimulus, and an electric field of 0.60 V/μm to 2.46 V/μm (preferably 0.61 V/μm to 2.37 V/μm) may be applied.

Referring to FIG. 5, when a reference temperature is set and the electric field E is applied to the liquid crystal layer 200 as the external stimulus, the liquid crystal layer 200 may transmit the light having the bandwidth of less than 30 nm toward the metasurface layer 100.

Specifically, referring to FIG. 5, when the reference temperature is set to 23° C. and an electric field of 2.14 V/μm is applied to the liquid crystal layer 200, light (purple) with a wavelength range of 410 nm to 440 nm may be transmitted toward the metasurface layer 100.

For example, when the reference temperature is set to 23° C. and an electric field of 1.98 V/μm is applied to the liquid crystal layer 200, light (blue) with a wavelength range of 440 nm to 460 nm may be transmitted toward the metasurface layer 100.

In addition, when the reference temperature is set to 23° C. and an electric field of 1.84 V/μm is applied to the liquid crystal layer 200, light (sky blue) with a wavelength range of 460 nm to 490 nm may be transmitted toward the metasurface layer 100.

In addition, when the reference temperature is set to 23° C. and an electric field of 1.72 V/μm is applied to the liquid crystal layer 200, light (light green) with a wavelength range of 500 nm to 530 nm may be transmitted toward the metasurface layer 100.

In addition, when the reference temperature is set to 23° C. and an electric field of 1.60 V/μm is applied to the liquid crystal layer 200, light (light green) with a wavelength range of 530 nm to 560 nm may be transmitted toward the metasurface layer 100.

In addition, when the reference temperature is set to 23° C. and an electric field of 1.52 V/μm is applied to the liquid crystal layer 200, light (yellow) with a wavelength range of 560 nm to 590 nm may be transmitted toward the metasurface layer 100.

In addition, when the reference temperature was set to 23° C. and an electric field of 1.45 V/μm is applied to the liquid crystal layer 200, light (orange) with a wavelength range of 590 nm to 620 nm may be transmitted toward the metasurface layer 100.

In addition, when the reference temperature is set to 23° C. and an electric field of 1.36 V/μm is applied to the liquid crystal layer 200, light (red) with a wavelength range of 620 nm to 650 nm may be transmitted toward the metasurface layer 100.

In addition, when the reference temperature is set to 23° C. and an electric field of 1.27 V/μm is applied to the liquid crystal layer 200, light (crimson) with a wavelength range of 660 nm to 690 nm may be transmitted toward the metasurface layer 100.

In addition, when the reference temperature is set to 23° C. and an electric field of 1.20 V/μm is applied to the liquid crystal layer 200, light (black) with a wavelength range of 700 nm to 730 nm may be transmitted toward the metasurface layer 100.

Referring to FIG. 6, when a reference electric field is set to 1.2 V/μm in the liquid crystal layer 200 and the temperature T is applied as the external stimulus, the liquid crystal layer 200 may transmit light having the bandwidth of less than 30 nm toward the metasurface layer 100.

Specifically, referring to FIG. 6, when the reference electric field is set to 1.2 V/μm and a temperature of 17.2° C. is applied to the liquid crystal layer 200, light (purple) with a wavelength range of 410 nm to 440 nm may be transmitted toward the metasurface layer 100.

For example, when the reference electric field is set to 1.2 V/μm and a temperature of 17.7° C. is applied to the liquid crystal layer 200, light (blue) with a wavelength range of 440 nm to 460 nm may be transmitted toward the metasurface layer 100.

In addition, when the reference electric field is set to 1.2 V/μm and a temperature of 18.2° C. is applied to the liquid crystal layer 200, light (sky blue) with a wavelength range of 460 nm to 490 nm may be transmitted toward the metasurface layer 100.

In addition, when the reference electric field is set to 1.2 V/μm and a temperature of 18.6° C. is applied to the liquid crystal layer 200, light (light green) with a wavelength range of 500 nm to 530 nm may be transmitted toward the metasurface layer 100.

In addition, when the reference electric field is set to 1.2 V/μm and a temperature of 19.2° C. is applied to the liquid crystal layer 200, light (light green) with a wavelength range of 530 nm to 560 nm may be transmitted toward the metasurface layer 100.

In addition, when the reference electric field is set to 1.2 V/μm and a temperature of 19.7° C. is applied to the liquid crystal layer 200, light (yellow) with a wavelength range of 560 nm to 590 nm may be transmitted toward the metasurface layer 100.

In addition, when the reference electric field is set to 1.2 V/μm and a temperature of 20.3° C. is applied to the liquid crystal layer 200, light (orange) with a wavelength range of 590 nm to 620 nm may be transmitted toward the metasurface layer 100.

In addition, when the reference electric field is set to 1.2 V/μm and a temperature of 21.1° C. is applied to the liquid crystal layer 200, light (red) with a wavelength range of 620 nm to 650 nm may be transmitted toward the metasurface layer 100.

In addition, when the reference electric field is set to 1.2 V/μm and a temperature of 22.0° C. is applied to the liquid crystal layer 200, light (crimson) with a wavelength range of 660 nm to 690 nm may be transmitted toward the metasurface layer 100.

In addition, when the reference electric field is set to 1.2 V/μm and a temperature of 23.0° C. is applied to the liquid crystal layer 200, light (black) with a wavelength range of 700 nm to 730 nm may be transmitted toward the metasurface layer 100.

Accordingly, the crosstalk between hologram images may be made to be close to zero even though a gap of an operating wavelength of the metasurface layer 100 is narrow (λop=30 to 40 nm). Here, the meaning that the crosstalk between the hologram images becomes zero may be understood as the meaning that multiple hologram images do not overlap and one hologram image appears.

For example, the light incident on the liquid crystal layer 200 may be light with a wavelength range of 400 nm to 750 nm or a wavelength range of 420 nm to 720 nm. In this case, only light having a narrow bandwidth of less than 30 nm or 30 nm or less according to the external stimulus may be transmitted to the metasurface layer 100.

In addition, the light incident on the liquid crystal layer 200 may be the light with the wavelength range of 400 nm to 750 nm. In this case, the light reflected from the liquid crystal layer 200 toward the metasurface layer 100 may be light in 10 different wavelength ranges according to the external stimulus. For example, a wavelength range of light emitted from the liquid crystal layer 200 may be light with a wavelength range of 410 nm to 430 nm, light with a wavelength range of 440 nm to 470 nm, light with a wavelength range of 470 nm to 500 nm, light with a wavelength range of 500 nm to 530 nm, light with a wavelength range of 530 nm to 560 nm, light with a wavelength range of 560 nm to 590 nm, light with a wavelength range of 590 nm to 620 nm, light with a wavelength range of 620 nm to 650 nm, light with a wavelength range of 660 nm to 690 nm, or light with a wavelength range of 700 nm to 730 nm according to the external stimulus.

As such, the light reflected from the liquid crystal layer 200 may have a sharp reflection waveform.

In addition, a reflectance of the light reflected from the liquid crystal layer 200 may be 40% or more, preferably 50% or more.

In addition, reflected light showing a reflectance of 10% or more may be provided so that wavelengths do not overlap, that is, crosstalk does not occur.

The unit liquid crystal molecule 201 provided as ChOH in the embodiment may be generated by mixing twist-bend nematic (NTB) LCs, typical nematic LCs, and chiral dopants.

The mixture represents a cholesteric phase at room temperature, may be converted to an isotropic phase above 78.1° C., and may converted to a chiral analog of NTB (NTB*) at 13.2° C.

When the electric field E is applied to the cholesteric phase (13.2° C. or more) of the mixture, the unit liquid crystal molecules 201 may form a spiral arrangement with a cone angle less than π/2.

The twisted-type liquid crystal composite 210 formed by twisting and bending the unit liquid crystal molecule 201 may form the pseudo-layer having the interlayer spacing P which may cause the Bragg reflection in the specific wavelength region.

The interlayer spacing P may be represented by the following equation.

$$P ( 2 π / E ) \sqrt{{K}_{3} / ( {ε}_{0} Δ ε )}$$

Here, K₃ may be understood as a bend elastic constant of the unit liquid crystal molecule 201, ε₀ may be understood as vacuum permittivity, and ε₀ may be understood as dielectric anisotropy.

In addition, a peak wavelength (λr) of the reflected light may be represented as follows.

λᵣ=n̅_{eff}P

Here, n̅_{eff} may be indicated as

$$( {n}_{e , eff} - {n}_{o} ) / 2 ( {n}_{e , eff} = {n}_{e} {n}_{o} / \sqrt{{n}_{e}^{2} {cos}^{2} θ + {n}_{o}^{2} {sin}^{2} θ} )$$

and may be understood as an effective extraordinary of n.

In addition, the bandwidth (Δλr) may be represented as follows.

Δλᵣ=Δn_{eff}P

Here, Δn_{eff} may be n_{e,eff}−nₒ and may be understood as an effective birefringence of the unit liquid crystal molecule 201.

In addition, the unit liquid crystal molecule 201 may be provided to have right-handed chirality.

In this case, the twisted-type liquid crystal composite 210 may be arranged in a shape that is twisted to the right with respect to the twisting axis k, and the liquid crystal layer 200 may reflect only right circularly polarized (RCP) light to the metasurface layer 100.

In this case, the metasurface layer 100 may be designed to operate in the right circularly polarized (RCP) light to generate a hologram.

Referring to FIG. 7, as an intensity of the electric field E of the liquid crystal layer 200 increases, the interlayer spacing P decreases, and a blueshift may occur.

For example, in the three figures shown in FIG. 7, the intensity of the electric field E may increase toward the right and accordingly, the interlayer spacing P may decrease. Accordingly, light representing red light, light representing green light, and light representing blue light may be generated in order from left to right.

When the electric field E is applied perpendicularly to the unit liquid crystal molecule 201, the unit liquid crystal molecule 201 may Bragg-reflect a specific wavelength (λr) to the metasurface layer 100.

Since the interlayer spacing P and a cone angle θ may be controlled by the electric field while maintaining a single harmonic structure, the unit liquid crystal molecule 201 may control the specific wavelength (λr) transmitted through the metasurface layer 100 from an ultraviolet region to a near-infrared region.

For example, as the electric field increases, the cone angle of the interlayer spacing P decreases, so that the light reflected toward the metasurface layer 100 may be blue-shifted.

In addition, according to the intensity of the external stimulus (e.g., electric field), the wavelength of light reflected from the liquid crystal layer 200 toward the metasurface layer 100 may be controlled, and different holograms may be generated by the light transmitted through the metasurface layer 100.

For example, when an electric field of 1.960 V/um is applied to the liquid crystal layer 200, light with a wavelength of 450 nm may be irradiated to the metasurface layer 100 and generate a hologram representing blue color and number 450.

In addition, when an electric field of 1.825 V/um is applied to the liquid crystal layer 200, light with a wavelength of 480 nm may be irradiated to the metasurface layer 100 and generate a hologram representing sky blue and number 480.

In addition, when an electric field of 1.4 V/um is applied to the liquid crystal layer 200, light with a wavelength of 640 nm may be irradiated to the metasurface layer 100 and generate a hologram representing red color and number 6400.

In addition, as another embodiment of the present disclosure, a hologram generating device including the stimuli-responsive meta-holographic device 10 described above may be provided.

The hologram generating device may include a stimuli-responsive meta-holographic device 10, a stimulus control device (not shown) capable of applying an external stimulus to a liquid crystal layer 200 of the stimuli-responsive meta-holographic device 10, and a light source (not shown) capable of irradiating light to the stimuli-responsive meta-holographic device 10.

Here, the stimulus control device (not shown) may apply different types of the external stimuli to the liquid crystal layer 200.

Light transmitted through the stimuli-responsive meta-holographic device 10 may generate as holograms having different shapes and colors according to the external stimuli.

The stimuli-responsive meta-holographic device 10 of the embodiment may be designed to be triggered by a plurality of external stimuli of different types, thereby presenting an advanced optical security device.

The metasurface layer 100 may be provided to be transmitted by light with a wavelength range of 420 nm and 720 nm to generate three or more different holograms.

For example, when a hologram is set to appear as a password at a specific electric field and temperature, both pieces of information should be present for the password to be decrypted. When only the electric field information or the temperature information is present, the password will not be known.

As such, when two people share the electric field information and the temperature information, decryption is only possible when both of the two people are present together. Since the liquid crystal layer 200 may be controlled by various external stimuli (electric field, temperature, magnetic field, light, electric field frequency, etc.), shared information will increase, and security will also be more advanced.

In the case of the embodiment, unlike a conventional optical-based forgery prevention device, it has a high degree of freedom in terms of adjustable optical characteristics, thereby having a superiority in information storage capacity and security level. In addition, when combined with IoT technology, it may be developed into a security device that communicates with a server in real time at a level that is impossible to be forged.

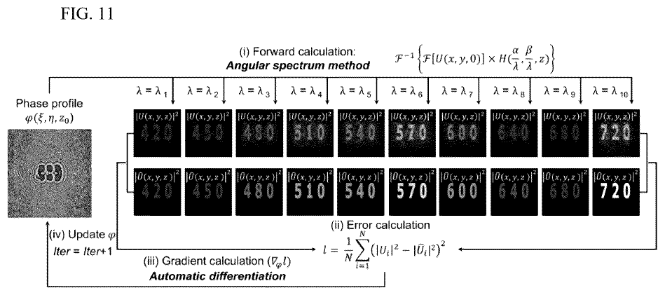

FIG. 11 is a conceptual view of an inverse design technique for designing a metasurface layer 100.

Referring to FIG. 11, the metasurface layer 100 generated by the inverse design technique will be described in more detail.

The inverse design technique may be understood as a design method that corrects a phase-map for a difference between a value that predicts a result of a particular phase profile and a target value from a specific phase profile and continues such a cycle to create a phase-map close to a desired target.

Referring to FIG. 11, an optimized loop may be composed of forward calculation and back propagation.

A single phase-map of the metasurface may be optimized to generate a hologram image that repeatedly converges to a target image at wavelengths of interest of λi=1, 2, . . . , 10. Here, focal distance of all holograms may be set to 800 μm.

This process may include an operation of inferring a single phase-map encoding pieces of a plurality of hologram information. This phase may be embodied by strategically disposing a nanostructure 101 at spatial coordinates specified thereafter.

The phase profile (φ) is considered as an optimization variable, and the phase may be retrieved to minimize an objective function 1.

The objective function 1 may be provided as the following equation.

$$l = \frac{1}{N} {\sum }_{i = 1}^{N} ( {\vert U ( {x}_{i} , {y}_{i} , z ) \vert}^{2} - {\vert \hat{U} ( {x}_{i} , {y}_{i} , z ) \vert}^{2} )$$

Here, |Û(xᵢ, yᵢ, z)| represents a target image and |U(xᵢ, yᵢ, z)| represents a calculated image.

The objective function 1 may be understood as a function that strategically evaluates a fidelity between the target image and the calculated image using a mean square error (MSE).

Steps for determining the phase represented by the nanostructure 101 disposed in the metasurface layer 100 are as follows.

An iterative process of phase retrieval represented by the nanostructure 101 may be provided as follows.
(i) In an initial step, an operation of calculating reconstructed images from a specified phase profile using an angular spectrum method may be executed.
(ii) Thereafter, the MSE may be measured by performing a comparative analysis between the reconstructed images and the target image.
(iii) In order to find an optimal solution, automatic differentiation may be used to calculate a gradient of the objective function with respect to the phase profile to calculate the gradient of the objective function 1 with respect to the phase profile.
(iv) In the final step, an operation of iteratively improving the phase profile according to the calculated gradient, with a goal of progressively reducing errors may be included.

Through such iterative improvement, encoding of the pieces of the plurality of hologram information may be encoded into a single phase profile, thereby improving the fidelity and the data storage capacity of the metasurface.

The nanostructure 101 may be designed by reflecting the following conditions in order to physically demonstrate a designed phase profile.

The designed nanostructure 101 should operate at all operating wavelengths using the same phase-map profile, and the designed nanostructure 101 should have high efficiency over an entire visible region.

In order to fully satisfy these conditions, a geometric phase having anisotropic meta-atoms may be used. A broadband operation may be understood as an inherent advantage of a geometric phase due to its wavelength independence, which generates the same phase-map profile regardless of wavelength.

In order to achieve high efficiency over an entire visible light spectrum region, nano-PER containing titanium dioxide (TiO2) nanoparticles may be used as a constituent material to implement high refractive index n, low extinction coefficient, and low dispersion relative to n.

In addition, titanium dioxide (TiO2) nanoparticles which are a printable material with high n, may enable single-step fabrication of the metasurface at low cost and high throughput using nanoimprint lithography, which will be one step closer to a practical device.

A rigorous coupled wave analysis (RCWA) may be used to simulate optical characteristics and calculate conversion efficiency of the nanostructure 101. The conversion efficiency may be calculated by varying geometric parameters of the nanostructure 101 in a target wavelength.

For example, the nanostructure 101 may be formed in a rectangular parallelepiped shape, the length of the nanostructure 101 may be provided between 320 nm and 430 nm, and the width of the nanostructure 101 may be provided between 60 and 160 nm.

In addition, the target wavelength may be provided at 420 nm, 450 nm, 480 nm, 510 nm, 540 nm, 570 nm, 600 nm, 640 nm, 680 nm, and 720 nm.

In addition, a spacing between the nanostructures 101 may be provided at 450 nm to suppress diffraction.

In addition, the length of the nanostructure 101 may be provided at 350 nm to 430 nm (preferably 390 nm), the width of the nanostructure 101 may be provided at 100 nm to 140 nm (preferably 120 nm), and the height of the nanostructure 101 may be provided at 900 nm to 980 nm (preferably 940 nm). In addition, the nanostructure 101 may represent a maximum average conversion efficiency at the target wavelength.

Although the stimuli-responsive meta-holographic device and the hologram generating device including the same according to the embodiments of the present disclosure have been described as specific embodiments, these are merely examples, and the present disclosure is not limited thereto, and it should be construed as having the best scope in accordance with the basic ideas disclosed herein. Those skilled in the art may combine and substitute the disclosed embodiments to implement embodiments not shown, and this also does not depart from the scope of the claims of the present disclosure. In addition, those skilled in the art may easily change or modify the disclosed embodiments based on this specification, and it is apparent that such changes or modifications fall within the scope the claims of the present disclosure.

What is claimed is:

1. A stimuli-responsive meta-holographic device comprising:
a metasurface layer provided with a plurality of nanostructures; and
a liquid crystal layer provided on one side of the metasurface layer and including a plurality of unit liquid crystal molecules of which arrangement is changed by an external stimulus;
wherein, when light is incident on the liquid crystal layer, the liquid crystal layer reflects light of a specific wavelength region to the metasurface layer according to a degree of the external stimulus applied thereon, and
the plurality of unit liquid crystal molecules are arranged to have a specific cone angle with respect to a twisting axis to form a twisted-type liquid crystal composite.

2. The stimuli-responsive meta-holographic device of claim 1, wherein the twisted-type liquid crystal composite is provided to have an interlayer spacing formed at a constant period in a longitudinal direction of the twisting axis, and
wherein the interlayer spacing is changed according to the external stimulus.

3. The stimuli-responsive meta-holographic device of claim 2, wherein the liquid crystal layer has a pseudo-layer that is regularly arranged in a two-dimensional or a three-dimensional form, and the pseudo-layer is formed by the interlayer spacing P of the twisted-type liquid crystal composite that is periodically arranged.

4. The stimuli-responsive meta-holographic device of claim 1, wherein the twisted-type liquid crystal composite has a spiral shape twisted around the twisting axis.

5. The stimuli-responsive meta-holographic device of claim 1, wherein the external stimulus is any one stimulus selected from a group consisting of an electric field, a temperature, a magnetic field, and an electric field frequency.

6. The stimuli-responsive meta-holographic device of claim 1, wherein the light incident on the liquid crystal layer is white light,
only the light of a specific wavelength region in the white light is reflected to the metasurface layer by the liquid crystal layer, and
a bandwidth of the light of a specific wavelength region reflected to the metasurface layer is provided to be less than 30 nm.

7. The stimuli-responsive meta-holographic device of claim 1, wherein the light incident on the liquid crystal layer is light with a wavelength range of 400 nm to 750 nm, and
wherein the light reflected toward the metasurface layer from the liquid crystal layer is light with 10 different wavelength ranges according to the external stimulus.

8. The stimuli-responsive meta-holographic device of claim 1, wherein the unit liquid crystal molecule is provided to have right-handed chirality, and
wherein the metasurface layer operates under right circularly polarized light to generate a hologram.

9. The stimuli-responsive meta-holographic device of claim 1, wherein the liquid crystal layer includes the twisted-type liquid crystal composite having an interlayer spacing formed at a constant period,
wherein the external stimulus is provided as an electric field, and
wherein the interlayer spacing decreases as an intensity of the electric field increases.

10. The stimuli-responsive meta-holographic device of claim 2, wherein the number of the interlayer spacings formed in the liquid crystal layer at the constant period is provided in 8 to 60.

11. The stimuli-responsive meta-holographic device of claim 1, wherein the nanostructure of the metasurface layer is formed in a rectangular parallelepiped shape having a length, a width, and a height, and
the length of the nanostructure is provided at 350 nm to 430 nm, the width of the nanostructure is provided at 100 nm to 120 nm, and the height of the nanostructure is provided at 900 nm to 980 nm.

12. The stimuli-responsive meta-holographic device of claim 1, wherein the liquid crystal layer is provided to reflect light in the specific wavelength region by different types of the external stimuli, and
wherein the different types of external stimuli include an electric field and a temperature.

13. The stimuli-responsive meta-holographic device of claim 1, wherein the metasurface layer is provided to be transmitted by light with a wavelength range of 420 nm to 720 nm to generate three or more different holograms.

14. The stimuli-responsive meta-holographic device of claim 13, wherein the metasurface layer is transmitted by light with the wavelength range of 420 nm to 720 nm to generate 10 different holograms.

15. The stimuli-responsive meta-holographic device of claim 13, wherein the metasurface layer is configured to be transmitted by light with a wavelength 420 nm, 450 nm, 480 nm, 510 nm, 540 nm, 570 nm, 600 nm, 640 nm, 680 nm, and 720 nm to generate 10 different holograms.

16. A hologram generating device comprising:
the stimuli-responsive meta-holographic device of claim 1;
a stimulus control device capable of applying an external stimulus to a liquid crystal layer of the stimuli-responsive meta-holographic device; and
a light source capable of irradiating light to the stimuli-responsive meta-holographic device,
wherein the stimulus control device is configured to apply different types of the external stimuli to the liquid crystal layer.

17. The hologram generating device of claim 16, wherein the light transmitted through the stimuli-responsive meta-holographic device generates as holograms having different shapes and colors according to the external stimuli.

18. The hologram generating device of claim 16, wherein the liquid crystal layer controls the wavelength of the light reflected toward the metasurface layer differently according to the external stimulus, and
the metasurface layer generates holograms having different shapes and colors according to the wavelength of the light incident from the liquid crystal layer.
